(19) United States
(12) Patent Application Publication
(10) Pub. No.: US 2019/0021358 A1
(43) Pub. Date: Jan. 24, 2019

(54) CHEESE PRODUCTS WITH ADDED MODIFIED PYRODEXTRINS

(71) Applicant: Cargill, Incorporated, Wayzata, MN (US)

(72) Inventors: John R. HEIGIS, Cedar Rapids, IA (US); Joseph L. KLEMASZEWSKI, Plymouth, MN (US)

(73) Assignee: Cargill, Incorporated, Wayzata, MN (US)

(21) Appl. No.: 15/755,730

(22) PCT Filed: Aug. 31, 2016
(86) PCT No.: PCT/US16/49574

§ 371 Date: Feb. 27, 2018

Related U.S. Application Data
(60) Provisional application No. 62/212,271, filed on Aug. 31, 2015.
(60) Provisional application No. 62/237,263, filed on Oct. 5, 2015.

(51) Int. Cl. A23C 19/068; A23C 19/082; A23C 19/086; A23C 19/09

(52) U.S. Cl. CPC A23C 19/0684; A23C 19/082; A23C 19/086; A23C 2240/15; A23V 2002/00; A23V 2250/5114; A23C 19/09

(57) ABSTRACT

Cheese products comprising less than 10 wt % modified pyrodextrin are disclosed. The cheese products with added modified pyrodextrin have similar melt, firmness, and stretch characteristics as compared to a cheese product without added modified pyrodextrin.

### Background

Cheese products have been made with at tied ingredients or components, such as starches and hydrocolloids used as protein extenders, but these cheese products do not always have the desired flavor and functionality of a cheese that does not include these added ingredients or components, some cheese products with high levels of starches, for example, the melt and stretch characteristics may be less than desired for use on pizzas and these cheese products may only be used in applications where these cheese products are not cooked. Mozzarella cheese products having starch extenders have been used commercially for a number of years because starch is an economical alternative to protein, but the amount of starch added is limited as the desired melt, stretch, or firmness characteristics of these Mozzarella cheese products are lost. Reduced protein mozzarella cheese, products made with conventional food starches replacing some of the cheese protein at levels of 1-3% starch can be too soft as the starch is not cooked out in the process and the cheese product cannot be shredded. In other examples, pregelatinized starches can be added to give a firmer cheese product, but these cheese products do not melt as well as cheese made without protein extenders. There is a need for a partial cheese protein replacement or substitution providing, an economical alternative and that will provide a cheese product having flavor and textural characteristics and properties that are comparable With a cheese product without partial cheese protein replacement or substitution.

### SUMMARY OF THE INVENTION

The present disclosure describes the use of and modified pyrodextrins in a cheese product, which may be used at higher levels than conventional food starches, while imparting characteristics and properties comparable to a cheese product without modified pyrodextrins at a significantly lower cost. A cheese product comprising a modified pyrodextrin of this disclosure (referred to herein as a “modified pyrodextrin cheese product”) may have characteristics and properties that are comparable to a variety of cheese products without added modified pyrodextrin such as, for example, cheddar, Mozzarella, asiago, Romano, provolone, parmesan, Colby or Monterey jack cheese products, as well as related processed and analogue cheeses.

In one embodiment of the present disclosure, higher levels of protein replacement are possible using the modified pyrodextrins disclosed in the present specification. In some embodiments, the modified pyrodextrin cheese product comprises less than 20, less than 15% and less than 10 wt % of a modified pyrodextrin and the modified pyrodextrin cheese product has similar melt, firmness and stretch characteristics compared to a cheese or cheese product without added modified pyrodextrin.

In some embodiments, the modified pyrodextrin is dextrinized nOSA substituted dent corn starch. In still other embodiments, the modified pyrodextrin is derived from high-amylose starch, waxy starch, dent starch, or combinations thereof.

The modified pyrodextrin cheese product of this disclosure may be further characterized by stretch, melt, and firmness characteristics. Suitable characteristics for cheese and cheese products used on pizzas, for example, are described by the USDA in a “Commercial item Description for Pizza Cheese Blends”, (A-A-20096A)), updated on Dec. 3, 2012. Suitable firmness characteristics are measured using aa TA.XT2i texture analyzer (Texture Technologies Corp., Hamilton, Mass.). In some embodiments, stretch characteristics determined using the procedures set out above are at least about 75%, 80%, 85%, 90%, 100%.,or more than 100% of the stretch characteristics of a cheese or cheese product without added modified pyrodextrin. In other embodiments, the melt characteristics determined using the procedures set out in the present specification are at least about 75%, 80%, 85%, 90%, 95%, 100%, or more than 100% of the melt characteristics of a cheese or cheese product without added modified pyrodextrin. In still other embodiments, the firmness characteristics determined using the procedures set out in the present specification are at least about 75%, 80%, 85%, 90%, 95%, 100%, or more than 100% of the firmness characteristics of a cheese or cheese product without added modified pyrodextrin.

In another embodiment, the present disclosure provides a method of making a cheese product comprising the step of substituting at least some protein of a cheese product with a modified pyrodextrin to provide the modified pyrodextrin cheese product, wherein less than 20 wt %, less than 15 wt %, and less than 10 wt % of the modified pyrodextrin cheese product is a modified pyrodextrin, and wherein the modified pyrodextrin cheese product has similar melt, fire mess and stretch characteristics compared to a cheese product without added pyrodextrin.

Still another embodiment is a process of making a modified pyrodextrin cheese product comprising the steps of (a) contacting a starch with an anhydride under suitable conditions to form a modified starch, (b) drying the modified starch, (c) contacting the modified starch with an acid for a sufficient period of time at a suitable temperature and pH to form a modified pyrodextrin, (d) adding the modified pyrodextrin to a cheese curd, a diced cheese, a shredded cheese, a dairy powder, a fat, or a combination thereof to form a mixture, and (e) cooking the mixture with mixing to form the modified pryodextrin cheese product. In an exemplary embodiment, a dairy powder is a suitable protein source such as, for example, rennet casein, milk protein concentrate, whey ingredients, skim milk, or combinations thereof and a fat is a suitable lipid such as for example, soybean oil, palm oil, butter, or combinations thereof.

In one embodiment of this process, the anhydride in step (a) is octenylsuccinic anhydride, the suitable temperature is about 85-95° F., and the pH is maintained at about 8.0-8.5 using 9% sodium hydroxide, and in step (c) the suitable temperature is about 200-300° F. and the pH is about 24 when the acid is hydrochloric acid. In other embodiments, the anhydride may be succinic anhydride or acetic anhydride. In still other embodiments, the modified starch may be made by reacting starch with propylene oxide or other chemical modifiers.

In the processes described in this specification the starch may comprise high-amylose starch, waxy starch, dent starch, or combinations thereof. Further, the starch may be selected from the group consisting of corn starch, tapioca starch, potato starch, pea starch, and, sago starch. Further, the, cheese curd, diced cheese, or shredded cheese may be selected, for example, from the group consisting of Mozzarella, low-moisture Mozzarella, Colby, Monterey jack, and cheddar cheese.

Yet another embodiment is a food product comprising the modified pyrodextrin cheese product of the present disclosure. In some embodiments, the food product is a pizza.

### DETAILED DESCRIPTION

The phrase “modified pyrodextrin cheese product” as used herein refers to a cheese product comprising modified pyrodextrin.

The phrase “cheese product” as used herein refers to a cheese that includes one or more added ingredient or components that would not be included in a cheese, such as, for example, a protein extender (as used herein the term “cheese” refers to a food composition comprising milk curd that has been, separated from the whey. Many varieties of cheese are known in the art, such as, for example, Mozzarella cheese, asiago cheese, Romano cheese, provolone cheese, parmesan cheese, cheddar cheese, Colby cheese and Monterey jack cheese.) Added ingredients or components ins a cheese product may include, for example, milk, cream, or other well-known dairy ingredients, such as casein and other proteins, as well as known salts, lipids, emulsifying salts, acidify agents, colorants, flavorings, spices or preservatives.

A cheese product may include both processed and analogue cheese, Processed cheese (also known as prepared cheese, plastic cheese, or cheese singles) is a food composition made from cheese or a mixture of cheeses (and sometimes other, unfermented, dairy by-product ingredients); plus emulsifiers, saturated vegetable oils, extra salt, food colorings, whey or sugar. Processed cheese exists in a variety of flavors, colors, and textures. Analogue cheese is generally described as a food composition that has properties similar to cheese, but in which constituents including milk fat and/or protein have been partly or completely replaced by other ingredients. Codex Alimetarious Commission, 1995, for example, describes analogue cheese as products that look like cheese in which milk fat has been replaced by other fats. Other examples of analogue cheese are reported, for example, in U.S. Pub. No. 20140154388 as well as in the article “Process Standardization for Rennet Casein Based Mozzarella Cheese Analogue”, J Food Sci Technol. 2010 October; 47(5): 574-578. Analogue cheeses vary from each other based on flavor, nutritional values, functionality, and in their applications. Many flavors of analogue cheese are found in the market, including American, Cheddar, and Monterrey Jack flavors.

In addition, analogue cheese may be categorized, based on its source of fats and proteins, as “partial dairy” or “nondairy”. If some fats and/or proteins come from dairy sources, while others have been replaced with non-dairy fats and/or proteins, these are referred to as partial dairy whereas if all fats and proteins come from non-dairy sources, these are referred to as “nondairy”. Compared to cheese, analogue cheese may be preferred nutritionally (e.g., based on fatty acid profiles), may be equal nutritionally or may be less preferred nutritionally in some cases. An analogue cheese may be used as a replacement for cheese in food products. One variant of analogue cheese may be designed to melt well on pizza, while also remaining chewy. An analogue cheese may be formulated for processing with basic cheese-making equipment and processing techniques that Mozzarella cheese requires, such as, for example, the processes of mixing and molding. Analogue cheese also may be made using cheese-making equipment which may not include a mixer molder.

The term “starches” as used herein refers to suitable starches which may be derived from a plant obtained by standard breeding techniques including crossbreeding, translocation, inversion, transformation or any other method of gene or chromosome engineering to include variations thereof. Additionally, starches derived from plants grown from artificial mutations and variations of the above generic composition which may be produced by known standard methods of mutation breeding are also suitable herein. Typical sources for the starch are cereals, tubers, roots, legumes and fruits. Native sources can be corn, pea, potato, sweet potato, banana, barley, wheat, rice, sago, amaranth, tapioca, arrowroot, canna, sorghum, and waxy or high amylose varieties thereof. As used herein, the term “waxy” is intended to include a starch or flour containing at least about 95% by weight amylopectin and the term “high amylose” is intended to include a starch or flour containing at least about 40% by weight amylose.

Modified starches may be used to produce modified pyrodextrins. Such modifications are intended to include without limitation cross-linked starches, acetylated and organically esterified starches, hydroxyethylated and hydroxypropylated starches, phosphorylated and inorganically esterified starches, cationic, anionic, nonionic, and zwitteronic starches, and succinate and substituted succinate derivatives of starch. Such modifications are known in the art and described, for example, in “Modified Starches: Properties and Uses”, Ed. Wurzburg, CRC Press, Inc., Florida (1986). Suitable starches, for example, may include pregelatinized instant starches, annealed or heat treated starches or granular starches. Conversion products derived from away of the starches, including fluidity or thin-boiling starches prepared by oxidation, enzyme conversion, acid hydrolysis, heat and or acid dextrinization, and or sheared products may also be useful herein.

In the present disclosure, modified pyrodextrins are used in cheese products, including, but not limited, to processed and analogue cheeses, to partially replace the functionality of protein by binding water and/or fat. Cheese product properties, including melt, stretch and firmness, are controlled by changing the properties of the modified pyrodextrin. In some embodiments, the modified pyrodextrin provides increased cheese product firmness with minimal impact on melt and stretch in, for example, a pizza cheese product. Other modified starch products may contribute increased firmness but cause reduced melt and stretch and would not be as suitable in, for example, a pizza cheese product.

There are well known methods and processes for determining cheese product characteristics. The USDA, for example, has standards for Mozzarella testing—melt and stretch. Details on the stretch test, for example, can be found in “Commercial Item Description”, Pub. No. A-A-20096A, Section 7.1.5, page 6 (2012).

Known starches currently used in cheese products may be limited because these starches may negatively impact the characteristics of the cheese product. For example, starches with a higher viscosity (e.g. pregelatinized HP starches) give a firmer cheese product that has melt restriction and less stretch on pizza. Cook up starches that are not solubilized is pasta filata machines do not impart any direct functionality, but give a softer cheese with graininess, limiting the amount of starch that can be added as the cheese is not able to shredded. Thinned instant starches have similar reduced viscosity and low gelatinization temperature, but unlike starches of the current disclosure, may restrict melt and stretch characteristics in the cheese product, and are typically not preferred in making cheese products.

In one embodiment, starch is first modified with n-octenylsuccinic anhydride (n-OSA) to form a modified starch. The modified starch is then dried and dextrinized with heat and acid to form modified pyrodextrin typically comprising 0.1 to 10 wt % octenylsuccinic anhydride and more preferably 0.25 to 4 wt % octenylsuccinic anhydride. Dextrinization of the modified starch with heat and acid allows for a higher incorporation level than starches currently used in cheese products or as used in cheese milk extension resulting in greater savings while maintaining the desired properties for particular applications like pizza. The modified pyrodextrins are soluble in cold water which facilitates use in both traditional and waterless cheese cookers.

The modified pyrodextrins described in this specification may be made using the known processes described, for example, in “Modified Starches: Properties and Uses”, Ed. Wurzburg, CRC Press, Inc., Florida (1986). Those skilled in the art would readily know how to produce the modified pyrodextrins suitable for use in, embodiments of the present disclosure.

### EXAMPLES

### Example 1 Starch Derivative and Dextrinization Processes

Starch Derivative

A 35% starch slurry (about 50 lbs. of starch combined with about 76.2 lbs. water) was prepared using Cargill Giel 04230 waxy corn starch (Lot Number HM2177) having a moisture content of 11.65%. The starch slurry temperature was adjusted to about 88-90° F. and the pH was adjusted to about 8.1 with the addition of 9% sodium hydroxide and then n-octenyl succinic anhydride (“-OSA”, about 150.5 grams) was added. Additional sodium hydroxide was added as necessary to maintain the pH between 8.1-8.25.

After about fifty minutes the heat was removed and the pH was adjusted to about 5.5 with 50% (aq.) hydrochloric acid. The slurry was then filtered and the starch cake was collected. The starch cake was re-slurried in water to twice the volume of the original slurry, the slurry pH was re-adjusted to pH 5.5. the slurry was dewatered using a filter press, and then dried.

Dextrinization

The dried starch (about 50-100 lbs.) was added to a pre-warmed, steam heated mixer reactor. When the starch temperature reached 150° F., anhydrous hydrochloric acid gas was added at about 4 grains/minute to the reactor to reach a set point of pH 3. Heating the reactor was continued to achieve a starch temperature of about 250° F. in 60 minutes.

The reaction was continued for 90-95 minutes and then heat was removed and the pyrodextrin was allowed to cool to room temperature.

### Examples 2-7

Experiments were conducted to produce modified pyrodextrins for this disclosure. Amylose 5 (high amylose starch), Waxy, and Common (Dent) starch sources were used in various dextrin reactions to evaluate the effect of botanical source in the cheese making process. The reaction parameters, including temperature and acid addition amount, remained constant for the reactions. Typically, these modified pyrodextrins had a target temperature range of 225° F. to 250° F. depending on the desired product. The pH for the experiments ranged from 2.8 to 3.2.

Examples 2-7 were produced with the following parameters in Table 1.

TABLE 1

| | | | Reaction | | |
|---|---|---|---|---|---|
| | | % n-OSA | Time in | | |
| Example | Source | Dosed* | minutes | Temperature ° F. | pH |
| 2 | Dent | 0.75 | 95 | 226 | 2.86 |
| 3 | Dent | 3.4 | 90 | 222 | 2.96 |
| 4 | Amy 5 | 0.75 | 90 | 226 | 3.1 |
| 5 | Amy 5 | 3.4 | 90 | 225 | 2.8 |
| 6 | Waxy | 0.75 | 90 | 225 | 3.16 |
| 7 | Waxy | 3.4 | 90 | 225 | 3.04 |

### Example 8

Modified pyrodextrin cheese products are made using the modified pyrodextrins of Examples 2-7 and other starches. Specifically, a Mozzarella cheese is made using typical make procedures of standardizing the milk to the desired fat content, pasteurization of the milk, culturing with lactic acid bacteria, addition of clotting enzyme, cutting curd, and draining of whey. Salt can be added by either direct addition to the cut curd or by brining. In this example, the Mozzarella cheese is formed into blocks of approximately eight pounds each and shredded within two days of manufacture. The shredded cheese is then frozen to stop changes associated with aging. The cheese is then thawed at 40° F. Shredded cheese, water, and modified pyrodextrin and starch are added to a steam jacketed Blentech twin screw cheese cooker which simulated a pasta filata process. The mixture is heated to 150-170° F. and held at this temperature for 2-5 minutes. The Mozzarella cheese product is poured into molding pans, covered and placed in a refrigerator for 5 days. After 5 days the cheese product is evaluated for firmness, shredded and followed by baking on a pizza.

Modified pyrodextrin cheese products utilizing the above process show an improvement, compared to cheese products using existing starches, in that the modified pyrodextrins.allow for higher incorporation levels, and correspondingly lower finished product cost, with less impact on cheese quality.

Various cheese products were made with varying levels of added carbohydrate and water as follows:

Low carbohydrate (LC): 90% cheese, 8% water, and 2% carbohydrate
High carbohydrate (HC): 88% cheese, 8% water, and 4% carbohydrate

Selected properties of the cheese products made and observations recorded, during the processing of these cheese products are listed in Table 2, below.

TABLE 2

| Cheese ID | Carbohydrate | ID | Moisture | Comments |
|---|---|---|---|---|
| Control | 100% cheese | Sunny Road | 39.7% | No additional mixing |
| | | Mozzarella | | and heating |
| 8A-LC | Sucrose | Granulated | 42.0% | No separation observed |
| | | sugar | | after processing |
| 8A-HC | Sucrose | Granulated | 40.9% | Water Separation |
| | | sugar | | observed at end of |
| | | | | processing |
| 8B-LC | Pregel corn starch | Cargill Gel | 44.1% | No separation observed |
| | | Instant ® 12030 | | after processing |
| 8B-HC | Pregel corn starch | Cargill Gel | 44.6% | Oil separation observed |
| | | Instant ® 12030 | | at end of processing. |
| 8C-LC | Cook up corn | PolarTex ® | 43.3% | No separation observed |
| | starch | 05736 | | after processing |
| 8C-HC | Cook up corn | PolarTex ® | 42.7% | No separation observed |
| | starch | 05736 | | after processing |
| 8D-LC | Thinned nOSA | Accubind ™ | 43.9% | No separation observed |
| | instant waxy corn | 12675 | | after processing |
| | starch | | | |
| 8D-HC | Thinned nOSA | Accubind ™ | 43.8% | No separation observed |
| | instant waxy corn | 12675 | | after processing |
| | starch | | | |
| 8E-LC | nOSA pyrodextrin | Experimental | 44.9% | No separation observed |
| | | code CRD | | after processing |
| | | 3037 | | |
| 8E-HC | nOSA pyrodextrin | Experimental | 44.2% | No separation observed |
| | | code CRD | | after processing |
| | | 3037 | | |

During the pasta filata process used to make the cheese products with added carbohydrates described above, it was common tor liquid to be expelled from t cheese during processing. All of the water was generally absorbed into the cheese by the end of processing. The two exceptions observed were cheese products, 8A-HC and 8B-HC (4% sucrose and 4% Cargill Gel® to Instant 12030). In the cheese product, 8A-HC (4% sucrose the primary ingredient) lost water and water soluble components like salt and sugar. This resulted in a concentration of the fat and protein and a firmer cheese than the cheese product, 8A-LC (with 2% added sucrose), as listed in Table 3. The cheese product 8B -HC (with 4% Cargill Gel® Instant 12030), was very thick during processing resulting in the emulsion breaking and the release of fat. This cheese product would be considered too thick to process in most commercial pasta filata equipment. Both cheese products that did not incorporate the carbohydrate ingredients, would be more expensive than the cheese products that did not have separation after processing due to the loss of yield.

After storing these cheese products for a minimum of 5 days, the cheese products were evaluated for firmness using a TA.XT2i texture analyzer (Texture Technologies Corp., Hamilton, Mass.), meltability, and stretch. Meltability was determined by placing cheese product discs having the same diameter and weight (6.5 g of cheese product is formed into a 22.5 mm diameter disc) on a dish in an oven where the temperature used was 232° C. for minutes. After melting and cooling the surface area of the melted cheese was determined and the percent increase in surface area compared to the unmelted cheese was calculated. Stretch characteristics of the cheese products were evaluated by heating 90 g of shredded cheese product to 240° C. for 6 minutes in an aluminum container. The cheese was cooled to approximately 80° C. and the cheese was stretched by pulling with a fork until the cheese broke, at which point the height was recorded. Properties of the cheese products are listed in Table 3.

TABLE 3

| | | | Stretch@ |
|---|---|---|---|
| Cheese ID | Firmness (kg) | Meltability | 80° C. |
| Control | 9.1 | 561% | 110 cm |
| 8A-LC | 5.8 | 730% | 70 cm |
| 8A-HC | 13.8 | 825% | 53 cm |
| 8B-LC | 8.2 | 538% | 120 cm |
| 8B-HC | 11.8 | 390% | 103 cm |
| 8C-LC | 10.8 | 463% | 107 cm |
| 8C-HC | 10.9 | 321% | 60 cm |
| 8D-LC | 8.0 | 573% | 87 cm |
| 8D-HC | 15.0 | 493% | 62 cm |
| 8E-LC | 5.5 | 846% | 117 cm |
| 8E-HC | 9.4 | 847% | 153 cm |

Cheese products with 2% added carbohydrate and 8% added water were generally closer to the control than their counterparts with 4% added carbohydrate. Firmness of the cheese decreased for all cheeses with 2% added carbohydrate due to the addition of water with the exception of sample 8C-LC made with PolarTex®05736. However, this starch showed some restriction in melt compared to the control which was more pronounced at the 4% addition rate. The increase in carbohydrate provided a firmer cheese with restricted melt and less stretch with two notable exceptions, sucrose and modified pyrodextrins. The increase in melt for the cheese with 4% sucrose was likely due to the composition changes already discussed and this cheese had decreased stretch compared the control and 2% added sugar. Surprisingly, both cheese products made with modified pyrodextrin showed superior melt and stretch compared to the control. Meltability was unchanged as the level of modified dextrin was increased from 2% to 4% and the stretch improved significantly at the 4% level. At the 4% level, the modified pyrodextrin had similar firmness to the control cheese, higher meltability, more stretch, lower fat, and lower cost.

### Example 9

In this Example, analogue cheeses, having the formulas and modified starches listed in Tables 4 and 5 below, were made using a commercially available modified potato starch as a control and improved products were made with pyrodextrin or modified pyrodextrin.

TABLE 4
Analogue Cheese Formula

| Ingredient | % |
|---|---|
| Rennet casein, 90 mesh | 16.0 |
| Salt | 1.7 |
| Water | 35.3 |
| Steam condensate | 11.5 |
| Palm Oil | 25.0 |
| Starch/pyrodextrin (see Table 5, | 8.0 |
| below) | |
| Sodium aluminum phosphate (basic) | 1.4 |
| Trisodium citrate | 0.9 |
| Citric acid | 0.2 |
| Total | 100 |

TABLE 5
Modified Starch used in Analogue Cheese Formula

| | Description |
|---|---|
| Control | 100% Thinned and modified potato starch |
| Pyrodextrin + starch | 58% PolarTex ® 05732 - substituted and |
| | cross-linked dent corn starch |
| | 42% Cargill Plus ™ 07701 - pyrodextrin from |
| | dent corn starch |
| Modified pyrodextrin + | 58% PolarTex ® 05732 - substituted and |
| starch | cross-linked dent corn starch |
| | 42% CRD 3037 - modified pyrodextrin from |
| | dent corn starch |

These analogue cheeses were made using a twin screw cheese cooker and aged a minimum of 5 days before evaluating. Tests included firmness, modified Schreiber melt, and stretch. The firmness and stretch tests used are described in Example 8. In this Example, the modified Schreiber melt was performed on analogue cheese discs having the same diameter and weight (6.5 g analogue cheese is formed into a 22.5 mm diameter disc) were melted on a dish in an oven at a temperature of 232° C. for 6 minutes, After melting and cooling, the surface area of the melted analogue cheese was determined and the increase calculated compared to the surface area of the winched analogue cheese, The results for these analogue cheeses are shown in Table 6.

TABLE 6
Characteristics of Analogue Cheeses Made with
Control Modified Potato Starch and Improved Alternative Starches

| Starch ID | Firmness (kg) | Melt | Stretch (cm) |
|---|---|---|---|
| Control | 5.9 | 447% | 14.5 |
| Pyrodextrin + starch | 3.5 | 547% | 24.5 |
| Modified | 7.4 | 538% | 28.0 |
| pyrodextrin + starch | | | |

In this Example, both pyrodextrins had better melt and stretch than the control. A surprising result was the increase in firmness from the n-OSA substituted pyrodextrin compared to both the control and non-substituted pyrodextrin. These pyrodextrins had significantly better attributes compared to the control modified potato starch and along with their lower cost, highlight the improvements of this invention.

Those skilled in the art will understand that these Examples represent a limited set of conditions and that one skilled in the art can utilize different blends of these components, different processing conditions, and different cheese types.

1. A cheese product comprising:
a modified pyrodextrin cheese product, wherein less than 20 wt % of the modified pyrodextrin cheese product is a modified pyrodextrin, and wherein the modified pyrodextrin cheese product has similar melt, firmness and stretch characteristics compared to a cheese product without added modified pyrodextrin.

2. The cheese product of claim 1, wherein less than 15 wt % of the modified pyrodextrin cheese product is a modified pyrodextrin.

3. The cheese product of claim 1, wherein less than 10 wt % of the modified pyrodextrin cheese product is a modified pyrodextrin.

4. The cheese product of claim 1, wherein the modified pyrodextrin is dextrinized starch.

5. The cheese product of claim 1, wherein the modified pyrodextrin is derived from dextrinized high-amylose starch, waxy starch, dent starch, or combinations thereof.

6. The cheese product of claim 1, wherein the modified pyrodextrin is derived from a modified starch with octenylsuccinic anhydride, wherein the modified pyrodextrin comprises 0.1 to 10 wt % octenylsuccinic anhydride.

7. The cheese product of claim 6, wherein the modified pyrodextrin comprises 0.25-3.4 wt % octenyl succinic anhydride.

8. (canceled)

9. (canceled)

10. The cheese product of claim 1, wherein the stretch characteristics are at least about 75% of the stretch characteristics of a cheese product without added modified pyrodextrin.

11. The cheese product of claim 1, wherein the melt characteristics are at least about 75% of the stretch characteristics of a cheese product without added modified pyrodextrin.

12. The cheese product of claim 1, wherein the firmness characteristics are at least about 75% of the stretch characteristics of a cheese product without added modified pyrodextrin.

13. (canceled)

14. A process of making a modified pyrodextrin cheese product comprising the steps of:
(a) contacting a starch with an anhydride under suitable conditions to form a modified starch;
(b) drying the modified starch;
(c) contacting the modified starch with an acid for sufficient period of time at a suitable temperature and pH to form a modified pyrodextrin;
(d) adding the modified pyrodextrin to a cheese curd, a diced cheese, a shredded cheese, a processed cheese, an analogue cheese, a dairy powder, a fat, or combinations thereof to form a mixture; and
(e) cooking the mixture with mixing to form the modified pyrodextrin cheese product.

15. The process of claim 14, wherein the starch comprises high-amylose starch, waxy starch, dent starch, or combinations thereof.

16. The process of claim 14, wherein the starch is selected from the group consisting of corn starch, tapioca starch, potato starch, pea starch, and sago starch.

17. The process of claim 14, wherein the acid is hydrochloric acid.

18. The process of claim 14, wherein the suitable temperature and pH in step (c) are temperatures of about 200-300° F. and a pH of about 2-4.

19. The process of claim 14, wherein the modified pyrodextrin is derived from starch and octenyl succinic anhydride.

20. The process of claim 14, wherein the suitable conditions in step (a) comprise reaction temperatures of 85-95 ° F. and a pH of about 8.0-8.5.

21. (canceled)

22. (canceled)

23. The process of claim 14, wherein the anhydride is selected from the group consisting of octenylsuccinic anhydride, succinic anhydride and acetic anhydride.

24. A food product comprising the cheese product of claim 1.

25. The food product of claim 24, wherein the food product is a pizza.
